(19) United States
(12) Patent Application Publication
(10) Pub. No.: US 2024/0061729 A1
(43) Pub. Date: Feb. 22, 2024

(54) MULTITENANCY CROSS-TENANT COLLABORATION DRIVEN BY EVENT PROXY

(71) Applicant: SAP SE, Walldorf (DE)

(72) Inventors: Jilin Xiong, Shanghai (CN); Zifeng Gu, Shanghai (CN)

(73) Assignee: SAP SE, Walldorf (DE)

(21) Appl. No.: 17/891,814

(22) Filed: Aug. 19, 2022

(51) Int. Cl. G06F 9/54; H04W 8/20; H04L 51/56

(52) U.S. Cl. CPC G06F 9/542; H04W 8/20; H04L 51/56

(57) ABSTRACT

A computer implemented method can receive an event object published by a source entity, parse the event object to retrieve an event message pertaining to an event awaiting processing and one or more target entities authorized to process the event, identify one or more receiving entities having subscribed to the event object from the one or more target entities, create a message queue connected with one or more message routes that directly link the source entity to the respective one or more receiving entities, and post the event message to the message queue.

### BACKGROUND

Multitenancy is a feature in many types of cloud computing services, such as infrastructure-as-a-service (IaaS), platform-as-a-service (PaaS), software-as-a-service (SaaS), containers, and serverless computing. In a multitenant cloud-based computing environment, one instance of a software application and supporting infrastructure can serve multiple entities or tenants. Thus, multiple tenants can share the same application and other computing resources running on the same operating system, on the same hardware, with the same data-storage mechanism(s). Even though resources are shared, each tenant can appear to have its own instance of the application and the underlying data of the tenants can be kept separate and secure. However, for a multitenancy enabled SaaS service in cloud, cross-tenant collaboration can be challenging because different tenants may use different information technology (IT) solutions which lack interoperability and it can be resource intensive to integrate these different IT solutions. Accordingly, room for improvement exists for supporting cross-tenant collaboration in a multitenant cloud-based computing environment.

### BRIEF DESCRIPTION OF THE DRAWINGS

FIG. 1 depicts an overall cloud-based computing system supporting multitenancy cross-tenant collaboration based on an event proxy platform.

FIG. 2 is a high-level architecture diagram depicting components of an example event proxy platform and its interactions with message brokers and related databases.

FIG. 3 is a flowchart illustrating an example overall method of implementing multitenancy cross-tenant collaboration driven by an event proxy platform.

FIG. 4 is an example diagram depicting a plurality of message queues created between a plurality of entities.

FIG. 5 is a block diagram of an example computing system in which described embodiments can be implemented.

FIG. 6 is a block diagram of an example cloud computing environment that can be used in conjunction with the technologies described herein.

### DETAILED DESCRIPTION

### Example 1—Overview of Cross-Tenant Collaboration in a Multitenant Environment

In a multi-tenant cloud-based computing system, a single software instance can serve multiple, distinct tenants or customers. For example, a SaaS provider can run a single instance of an application and offer access to individual tenants. Each tenant's data can remain isolated, although it can access the same software as other tenants.

Nowadays, business processes often exceed organizational boundaries. However, for a multitenancy enabled SaaS service in the cloud, cross-tenant collaboration can be challenging because different tenants may use different IT solutions which lack interoperability. For example, in supply chain finance business, the process often involves multiple organizations or entities (e.g., suppliers, buyers/distributors, banks, etc.) which form a network to complete an end-to-end financing scenario. These different entities may use different IT software that is provided by different vendors. As a result, it can be difficult to integrate the different IT software to smoothly handle tasks involving cross-tenant transactions so that a request sent from one tenant can be promptly and reliably handled by another tenant.

One conventional approach to integrate multiple IT solutions to support cross-tenant collaboration is using application programming interface (API) calls. However, this approach is inefficient because API calls need to be actively invoked by entities involved in collaborative transactions. For example, a tenant may have to frequently and/or periodically invoke an API call to check the status of a business transaction in order to take certain actions and/or generate a response. This can be problematic when timely or real-time response is desired. Moreover, system integration which is built on APIs often leads to a high cost and system dependency. For example, dedicated integration software application must be developed using specific APIs to enable cross-tenant communication and data exchange. When a tenant upgrades or changes its IT solution, the previously developed integration software may have to be updated due to changes of the corresponding APIs. As a result, system extensibility can be limited.

The technology described herein can overcome the shortcomings described above by using an event proxy platform, which can provide a secure, reliable, and extensible event handling mechanism that support cross-tenant collaboration in a multitenant cloud-based computing environment.

### Example 2—Example Overview of Cloud-Based Computing System Supporting Cross-Tenant Collaboration Driven by Event Proxy Platform

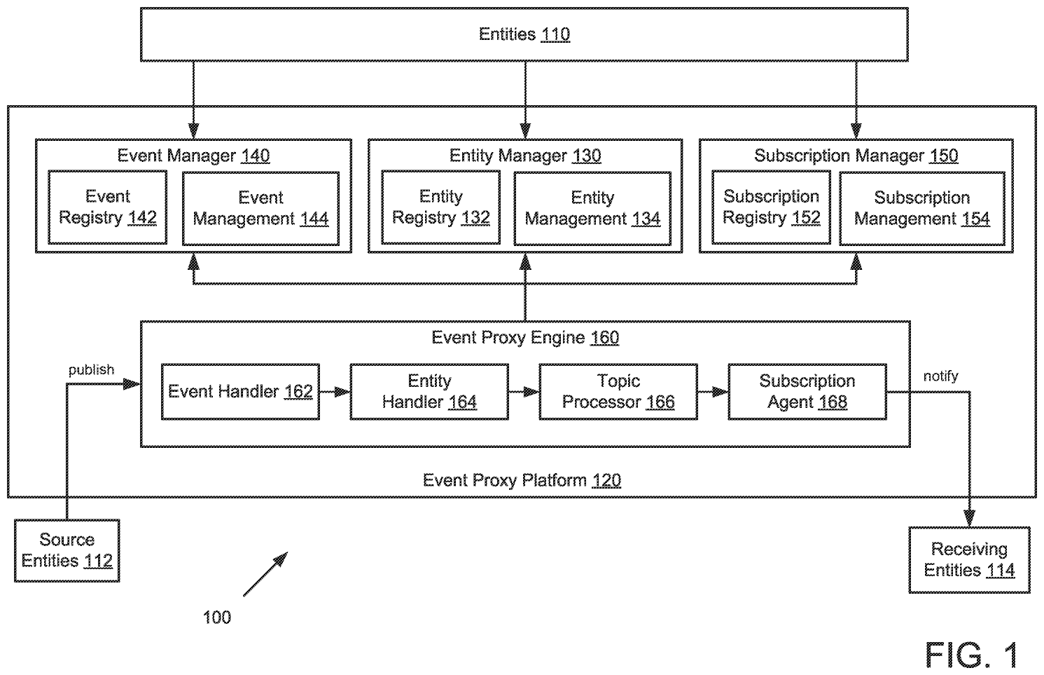

FIG. 1 shows an overall cloud-based computing system 100 supporting multitenancy cross-tenant collaboration according to certain examples.

As shown, the system 100 includes a plurality of entities/tenants 110 interacting with an event proxy platform 120. The event proxy platform 120 provides a central event repository which can be deployed on a cloud-based computing environment as a SaaS solution. Entities 110 registered with the event proxy platform 120 can collaborate with each other through a secure and efficient event-driven messaging mechanism as described below.

The event proxy platform 120 includes an entity manager 130, an event manager 140, a subscription manager 150, and an event proxy engine 160. The entity manager 130 can include an entity registry 132 and an entity management unit 134. The event manager 140 can include an event registry 142 and an event management unit 144. The subscription manager 150 can include a subscription registry 152 and a subscription management unit 154. The event proxy engine 160 can include an event handler 162, an entity handler 164, a topic processor 166, and a subscription agent 168.

In practice, the systems shown herein, such as system 100 (and 200 described further below), can vary in complexity, with additional functionality, more complex components, and the like. For example, there can be additional functionality within the event proxy engine 160. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the registries, events, subscriptions, and the like can be stored in one or more computer-readable storage media or computer-readable storage devices. The technologies described herein can be generic to the specifics of operating systems or hardware and can be applied in any variety of environments to take advantage of the described features.

### Example 3—Example Registration and Management of Entities

The entity management unit 134 can be a software application configured to manage life cycles of entities 110 registered with the event proxy platform 120. Specifically, the entity management unit 134 can interact with the entity registry 132, which can be a data file stored in a database that defines all entities registered with the event proxy platform 120. For example, when an entity first registered with the event proxy platform 120, relevant registration information about the entity (e.g., entity identification, login credentials, access permissions, messaging software interfaces, etc.) can be stored in the entity registry 132. Such registration information can be edited/changed by the registered entity or by an administrator of the event proxy platform 120 as needed. When a registered entity is no longer interested in collaborating with other entities, the registration information about this entity can be removed from the entity registry 132.

### Example 4— Example Registration and Management of Event Objects

The event management unit 144 can be a software application configured to manage life cycles of event objects registered with the event proxy platform 120. Specifically, the event management unit 144 can interact with the event registry 142, which can be a data file stored in a database that defines all event objects registered with the event proxy platform 120.

An event object registered in the event registry 142 refers to a software artifact representing an object in the physical world that has business significance for an entity, and the event object needs to be communicated to at least another entity which can take an action in response to complete a business process or transactions. Example event objects include purchase orders, accounting documents, delivery notes, or the like. Some of the event objects can be predefined or pre-delivered by an enterprise software provider (e.g., a standard purchase order object generated by an enterprise software). Some of the event objects can be user-defined or customized.

As described herein, only registered entities can register event objects in the event registry 142. For example, through the event management unit 144, an entity listed in the entity registry 132 can register an event object in the event registry 142. A registered event object can have a predefined structure containing a plurality of fields, as described further below. After an event object is registered in the event registry 142 by a registered entity, the registered entity and/or an administrator of the event proxy platform 120 can edit/change one or more fields of the registered event object, as needed. When the registered event object is no longer needed (e.g., the entity will not publish the event object), the entity who registered the event object and/or the administrator of the event proxy platform 120 can delete (or archive) the event object from the event registry 132.

Registration of an event object is a prerequisite for publishing the event object. In other words, an entity can publish an event object in the event proxy platform 120 (so that subscribers of the event object can be notified and take actions in response to the published event object) only after the entity first registered the event object in the event registry 132.

In addition to managing the life cycle of event objects, the event management unit 144 can also be configured to collect, monitor, log, and display status and/or statistics of the event objects registered in the event registry 142, as well as status and/or statistics of any published event objects (e.g., number of subscriptions for any published event object, whether or not a published event object is consumed/used by a subscribing entity, duration of a posted event message associated with a published event, etc.).

### Example 5—Example Event Object Structure

As described above, an event object is a software artifact representing an object in the physical world. The event object can have a predetermined structure including a plurality of fields and values corresponding to the fields. The event object can be written in different programming languages. As an example, a structure of an event object written in JSON format can be described as following:

```
EventObject Obj{
    “Topic”: “topic_a”,
    “Name”: “event_1”,
    “Parameter”: [ ],
    “Data”: [. . .],
    “Timestamp”: “2022-04-01 0:00:00”,
    “Source”: “entity_a”,
    “Target”: “entity_b”
}
```

In this example, the event object Obj has a number of fields, including: a “Topic” field which specifies a topic or category of the event object; a “Name” field which specifies a name or identifier of the event object; a “Parameter” field which can include (optional) condition parameters specifying conditions to handle the event object; a “Data” field indicating payload of the event object (which can include an event message to be passed to another entity); a “Timestamp” field which indicates when the event object is published; a “Source” field which specifies a source entity who publishes the event object; and a “Target” field which specifies which one or more entities who are authorized by the source entity to receive the event object. The field names can be predefined. In some examples, additional fields can be added to the event object, such as data privacy and protection (“DPP”) protocols, e.g., GDPR, CCPA, etc.

### Example 6—Example Registration and Management of Event Subscriptions

The subscription management unit 154 can be a software application configured to manage life cycles of event subscriptions registered with the event proxy platform 120. Specifically, the subscription management unit 154 can interact with the subscription registry 152, which can be a data file stored in a database that defines all event subscriptions registered with the event proxy platform 120.

As described herein, only registered entities can register event subscriptions in the subscription registry 152. Each event subscription corresponds to a specific registered event object or a group of event objects that share a specific “topic.” For example, through the subscription management unit 154, an entity (e.g., A) listed in the entity registry 132 can subscribe to an event object registered in the event registry 142 by another entity (e.g., B), and such event subscription can be stored in the subscription registry 152. By subscribing to a registered event object, the entity (e.g., A) will receive notification anytime when the event object is published by the other entity (e.g., B). After an event subscription is registered in the subscription registry 152 by a registered entity, the registered entity and/or an administrator of the event proxy platform 120 can edit/change the event subscription (e.g., subscribe to another registered event object, etc.), as needed. When the event subscription is no longer needed (e.g., the entity does not want to be notified of newly published event object), the entity who registered the event subscription and/or the administrator of the event proxy platform 120 can delete the event subscription from the subscription registry 152.

In addition to managing the life cycle of event subscriptions, the subscription management unit 154 can also be configured to collect, monitor, log, and display status and/or statistics of the event subscriptions registered in the subscription registry 152, e.g., the number of event subscriptions associated with each registered entity, etc.

### Example 7—Example Overview of Runtime Operation of Event Proxy Engine

While the entity manager 130, event manager 140, and subscription manager 150 operate to define and manage the life cycles of entities, event objects, and event subscriptions, respectively, the event proxy engine 160 operates in runtime to coordinate actions between entities, e.g., one or more source entities 112 and one or more receiving entities 114, to complete a business process or transactions. Both the source entities 112 and the receiving entities 114 refer to those entities 110 that have been registered in the entity registry 132.

As shown in FIG. 1, each source entity 112 can publish an event object to the event proxy engine 160. The published event object can be processed by an event handler 162, which, in certain cases, can perform a validity check to ensure the published event object is registered in the event registry 142.

The event handler 162 is configured to parse the event object to retrieve values corresponding to different fields in the event object. For example, the event handler 162 can retrieve an event message (e.g., the value corresponding to the “Data” field) and one or more target entities (e.g., the value corresponding to the “Target” field) from the event object. The event message includes data about an event awaiting processing, and the one or more target entities are authorized (by a source entity 112) to process the event. For example, the event object published by a source entity 112 can be a purchase order. In this case, the event message can include detailed information pertaining to the purchase order, and the target entities specify which entities are authorized by the source entity 112 to process the purchase order. In certain circumstances, the event handler 162 can also retrieve other information from the event object, such as a topic of the event object (e.g., the value corresponding to the “topic” field), condition parameters (e.g., the value corresponding to the “Parameter” field), timestamps, DPP protocols, etc.

The entity handler 164 is configured to map a source entity 112 to the target entities specified in the published event object. Such mapping effectively isolates the published event object to a selected (and usually a smaller) group of target entities who are authorized by the source entity 112 to receive and process the event represented by the event object. In other words, entities that are not specified as target entities will not receive notification of the publication of the event object by the source entity 112. In certain cases, the entity handler 164 can perform a validity check to ensure the target entities specified in the published event objects are registered in the entity registry 132.

The subscription agent 168 is configured to identify the receiving entities 114 from the target entities by checking the subscription registry 152. A target entity is determined to be a receiving entity 114 if the target entity has a subscription to the published event object. Contrarily, if a target entity has not subscribed to the published event object, that target entity is deemed not a receiving entity 114. In other words, a target entity authorized by the source entity 112 may not be a receiving entity 114. A receiving entity 114 must both be authorized by the source entity 112 and has a subscription to the published event object.

After identifying the receiving entities 114, dedicated message channels (which can also be referred to as “tunnels” or “routes”) that directly link a source entity 112 to the respective receiving entities 114 can be established. A message queue can be created and connected to the message channels. The event message retrieved from the published event object can then be posted to the message queue. Responsive to the posting, notifications can be sent to the receiving entities 114. Each dedicated message channel has a direct and specific point-to-point connection (e.g., connecting a specific source entity 112 to a specific receiving entity 114) and such dedicated message channel is isolated from other message channels.

After receiving the notification, the receiving entities 114 can receive (also referred to as “consume”) the event message, and take actions to process the event (e.g., processing the purchase order, etc.) based on the event message. In some cases, after the receiving entities 114 consume the event message, the posted event message can be removed from the message queue. In certain cases, after a predefined duration has elapsed/passed since posting the event message to the message queue (and no receiving entity has responded to the event), the event message can also be deleted from message queue. In some cases, the message queue and the associated message channels that link a source entity 112 and the corresponding receiving entities 114 can be released or destructed after the posted event message has been consumed by the receiving entities 114.

In some circumstances, the published event object can specify one or more condition parameters, which specify conditions for consuming the event. For example, certain condition parameters can specify that a consumption of the event must be completed within a predefined duration. Thus, if the event is not consumed within the predefined duration, the published event object can be deleted or archived.

As another example, the source entity 112 can set certain condition parameters which specify some standards or criteria for the receiving entities 114 to handle the event. If a receiving entity 114 does not meet such standards or criteria, the receiving entity 114 will not receive notification of this published event object even if the receiving entity 114 has subscribed to this event object. For example, the source entity 112 can specify an industry certification as a condition parameter for a purchase order event object. A receiving entity 114 who has subscribed to the purchase order event object will not receive notification of the purchase order event object if the receiving entity 114 does not have the specified industry certification.

In certain aspects, a receiving entity 114 can also specify condition parameters during subscription. If a published event object does not meet the specified condition parameters, the receiving entity 114 will not get notified by this published event object even if the receiving entity 114 has subscribed to this event object. For example, the total amount of a purchase order can be a condition parameter of an event object. A receiving entity 114 who has subscribed to the purchase order event object may want to get notified only if the total amount of the purchase order is larger than $1 million. Thus, if the total amount of a purchase order is less than $1 million, the receiving entity 114 will not receive notification.

In some circumstances, after taking appropriate actions in response to the posted event message, e.g., fulfilling a purchase order, a receiving entity 114 can notify and send the completed purchase order to the source entity 112. Such notification can also be event-driven. For example, the entity 114 can publish another event object including an event message containing the completed purchase order and specifying the entity 112 as a target entity. If the entity 112 subscribes to such event object, the entity 112 can receive the completed purchase order through a dedicated message channel established between the entities 114 and 112. In this example, the roles of entities 112 and 114 are switched, e.g., the entity 114 becomes the source entity and the entity 112 becomes the receiving entity.

In some circumstances, the topic processor 166 can be configured to filter who can receive the event message based on the topic retrieved from the published event object. The topic can be specified by the source entity 112 and indicate what type of event is associated with the published event object. In certain aspects, the topic can be used to identify a group of event objects, to which one or more receiving entities 114 can subscribe. For example, the “purchase order” can be a specified topic, which represents a group of related event objects including “purchase order creation,” “purchase order update,” and “purchase order deletion.” During the subscription step, a receiving entity 114 can subscribe to the “purchase order” topic (instead of subscribing to individual event objects separately). As a result, all event objects belonging to the “purchase order” topic are subscribed by the receiving entity 114. Thus, when a new event object is introduced later for this same topic (e.g., a “purchase order authorization” is added to the “purchase order” topic), this new event object will automatically be subscribed by the receiving entity 114 (without the need for the receiving entity 114 to subscribe to this new event object separately).

In FIG. 1, the entity handler 164 is arranged after the event handlers 162 and before the topic processor 166. In other examples, the logical sequence of the entity handler 164 and the topic processor 166 can be switched, e.g., the topic processor 166 can be arranged after the event handler 162 and before the entity handler 164. In some examples, the event proxy engine 160 can include additional modules configured to implement additional functions, such as DPP handling, as described further below.

### Example 8—Example System Architecture Supporting Cross-Tenant Collaboration Based on Event Proxy Platform

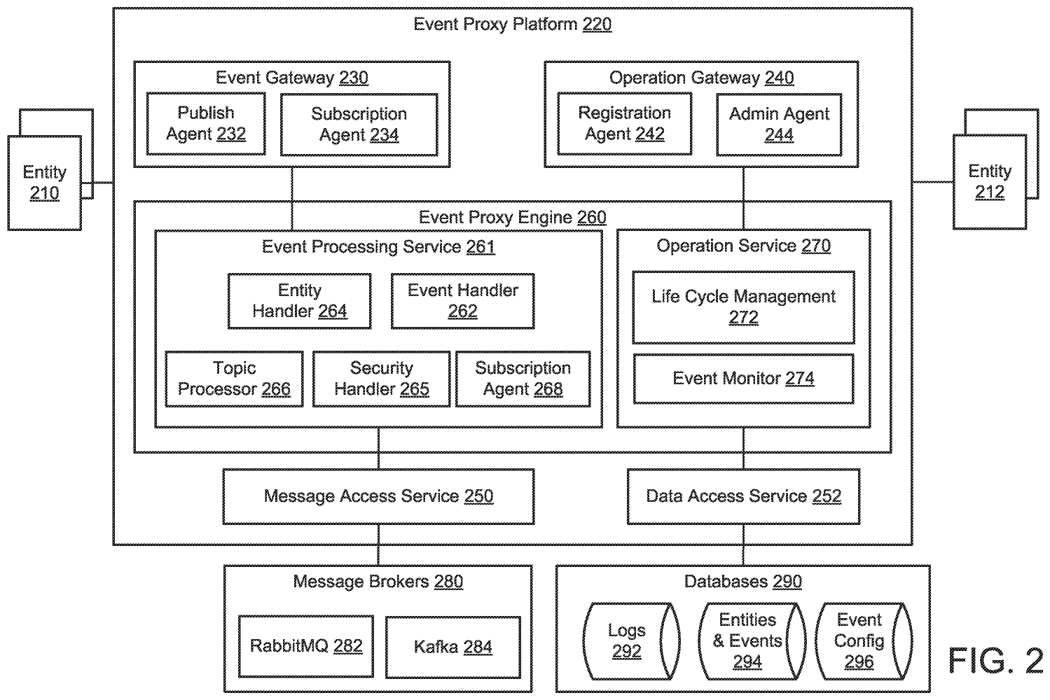

FIG. 2 is a high-level architecture diagram depicting functional components of an example event proxy platform 220 and its interactions with message brokers 280 and related databases 290. The event proxy platform 220 can be an example embodiment of the event proxy platform 120 of FIG. 1.

Similar to FIG. 1, a plurality of entities 210, 212 can communicate with each other through the event proxy platform 220. The event proxy platform 220 includes three layers of functional modules: a top layer including an event gateway 230 and an operation gateway 240, a middle layer including an event proxy engine 260, and a bottom layer comprising a message access service 250 and a data access service 252. As shown in FIG. 2, the event proxy platform 220 is configured to communicate with external message brokers 280 and databases 290.

The event proxy engine 260 can be an example embodiment of the event proxy engine 160 of FIG. 1. The event proxy engine 260 includes an event processing service 261 and an operation service 270. The event processing service 261 is configured to communicate with the event gateway 230 at one end and the message access service 250 at the other end. The operation service 270 is configured to communicate with the operation gateway 240 at one end and the data access service 252 at the other end.

The top layer provides an interface between the entities 210, 212 and the event proxy engine 260. Specifically, the operation gateway 240 provides a user interface for external entities (e.g., 210, 212, etc.) to perform entity/event registration and related administration tasks by calling the operation service 270. As shown, the operation gateway 240 includes a registration agent 242, which is configured as a user interface for registering entities and event objects. The operation gateway 240 also includes an admin agent 244, which is configured as a user interface for browsing/searching, editing, and/or displaying status/statistic information of the registered entities and event objects.

The event gateway 230 provides a user interface for external entities (e.g., 210, 212, etc.) to publish and/or subscribe to event objects by calling the event processing service 261. As shown, the event gateway 230 includes a publish agent 232, which is configured as a user interface for a registered entity to publish one or more registered event objects. The event gateway 230 also includes a subscription agent 234, which is configured as a user interface for a registered entity to subscribe to one or more registered event objects. In some examples, the admin agent 244 can also browse/search/display status/statistic information of the event subscriptions. In some examples, the subscription agent 234 can be implemented as a part of the subscription manager 150 of FIG. 1.

The event processing service 261 is configured to handle all processes between publishing an event object by a source entity and sending notifications to receiving entities. For example, after the publish agent 232 receives a request from a source entity to publish an event object, the event handler 262 (similar to 162) can parse the event object to retrieve relevant event information, such as event message, target entities, topic, DPP protocols, etc. The entity handler 264 (similar to 164) can map the source entity to the target entities. The subscription agent 268 (similar to 168) can identify receiving entities based on event subscriptions provided by the subscription agent 234, and create dedicated message channels linking the source entity to the respective receiving entities. By calling the message access service 250 to invoke the message brokers 280, the event processing service 261 can post the event message to a message queue connected to the dedicated message channels. Responsive to the posting, notifications can be sent to the receiving entities. In certain examples, the topic processor 266 (similar to 166) can filter who can receive the event message based on the topic retrieved from the published event object, wherein each topic can represent a group of event objects.

Additionally, a security handler 265 can be configured to manage data security/privacy aspects of the event message based on specified DPP protocols. For example, if the event message contains personal data that is not compliant with the DPP protocols, such personal data can be masked, encrypted, and/or removed before posting the event message to the message queue. In another example, if the event message has remained in the message queue (without being consumed by a receiving entity) for a prolonged duration that exceeds a retention period specified in the DPP protocols, the event message can be removed from the message from the message queue, and the published event object can be deleted and/or archived.

Interacting with the operation gateway 240, the operation service 270 includes a life cycle management unit 272 configured to perform actions related to life cycles of entities and event objects that have been registered through the registration agent 242. Example life cycle management activities include creating, updating, deleting/archiving, and reading/indexing registered entities and/or event objects. Such life cycle management activities can be performed by interacting with external databases 290 through the data access service 252. The operation service 270 also includes an event monitor 274, which is configured to monitor, in real-time or substantially real-time, status and/or statistics of any published or runtime event objects (e.g., through the publish agent 232). In some examples, the operation gateway 240 and the operation service 270 can be implemented as parts of the entity manager 130 and event manager 140 of FIG. 1.

The message access service 250 provides a low-level interface to the message brokers 280, which can include any number of message-oriented middleware that can translate a message from a formal messaging protocol of a message sender to a formal messaging protocol of a message receiver. Example message brokers include RabbitMQ 282, Apache Kafka 284, or the like. Generally, a message broker 280 can start a message queue, monitor the status of an event message posted on the message queue, determine whether a posted event message is consumed by a receiving entity, etc. The message queues created by the message brokers 280 can be connected to the dedicated message channels established by the event processing service 261.

Thus, by encapsulating the event proxy engine 260 and the message access service 250 within the event proxy platform 220, entities 210, 212 do no need to know the APIs of specific message brokers (e.g., 282, 284). Instead, entities 210, 212 only need to have access to the operation gateway 240 and event gateway 230 to use the messaging services provided by the message brokers 280. In other words, the event proxy platform 220 provides a low-code/no-code application environment where different entities 210, 212 can collaborate through event-driven message channels using a simplified user interface, without the overhead of learning technical details of specific message brokers 280 (i.e., the technical implementation of the message brokers 280 is hidden from the entities 210, 212).

The database access service 252 provides a low-level read/write interface to the external databases 290, which can include structured and/or unstructured data pertaining to registered entities and event objects 294, configuration information of registered event objects 296, and data logs 292, etc. In some examples, the entities and event objects 294 can contain entity registry 132 and event registry 142 of FIG. 1. In some examples, the event configuration 296 can contain subscription registry 152 of FIG. 1. In some examples, actions taken by the entities 210, 212 (e.g., registering an event object, publishing an event object, subscribing to an event object, etc.) and/or data generated by the event processing service 261 (identified receiving entities, retrieved event messages, topics, condition parameters, DPP protocols, notifications, etc.) can be recorded in the data logs 292, which can be retrieved for analysis and reporting purposes.

### Example 9—Example Overall Method of Cross-Tenant Collaboration Driven by Event Proxy Platform

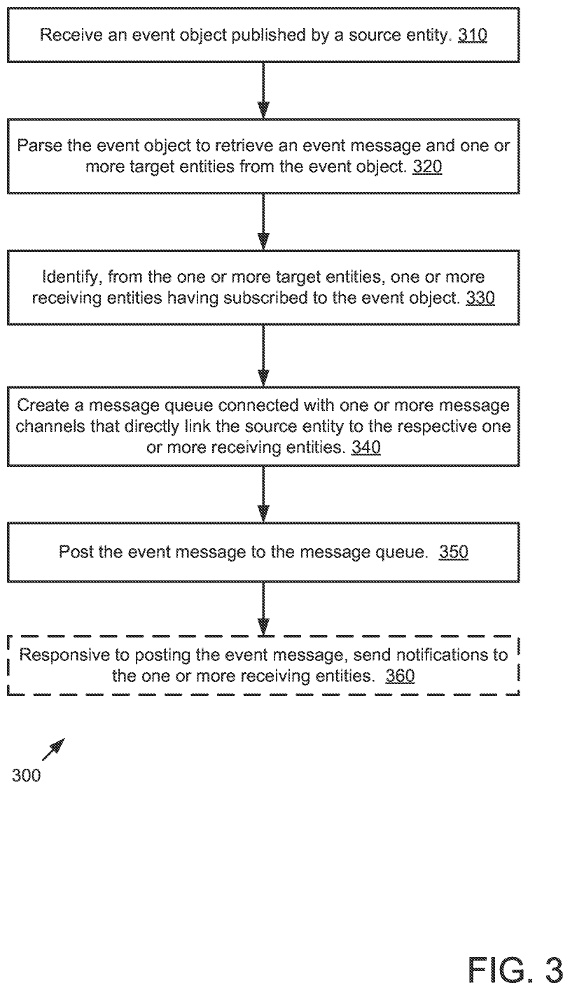

FIG. 3 is a flowchart of an example overall method 300 of implementing cross-tenant collaboration through an event proxy platform, and can be performed, for example, by the system of FIG. 1.

At 310, the method 300 can receive an event object published by a source entity (e.g., 112). As described above, the source entity must be first registered with an event proxy platform (e.g., via the entity manager 130), and the event object must be previously registered with the event proxy platform by the source entity (e.g., via the event manager 140).

At 320, the method 300 can parse the event object to retrieve an event message and one or more target entities from the event object. The event message includes data about an event awaiting processing. The one or more target entities are authorized by the source entity to process the event. As a result, mapping between the source entity and the entities can be established. As described above, parsing of the event object can be performed, e.g., by an event handler (e.g., 162) of the event proxy platform.

At 330, the method 300 can identify, from the one or more target entities, one or more receiving entities having subscribed to the event object (e.g., via the subscription manager 150). As described above, only registered entities can register event subscriptions.

At 340, the method 300 can create a message queue connected with one or more message channels that directly link the source entity to the respective one or more receiving entities. As described above, each message channel has a specific point-to-point connection and is isolated from other message channels, and the creation of the message queue can be performed by calling message brokers (e.g., 280) external to the event proxy platform.

At 350, the method 300 can post the event message to the message queue. Similarly, posting of the event message to the message queue can be implemented by the external message brokers.

In some examples, responsive to the posting, the method 300 can further send notifications to the one or more receiving entities. Due to the isolation of message channels, only identified receiving entities can receive or consume the event message included in the published event object.

The method 300 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### Example 10—Example Message Queues in an Entity Network

As described herein, the message queue refers to a form of asynchronous message communication between at least two entities. After posting an event message to a message queue, the event message stays on the message queue until it is consumed by at least one receiving entity and then deleted from the message queue.

In some examples, a message queue can be created between one source entity and multiple receiving entities. In some examples, an event message of the source entity posted on the message queue is consumed when any of the receiving entities consumes the event message.

In some examples, a receiving entity can be connected to multiple source entities through respective message queues. When the receiving entity consumes an event message posted on one of the message queues, event messages posted on other message queues are not affected.

In some examples, an entity publishing an event object (i.e., playing the role of a source entity) can also subscribe to event objects published by other entities (i.e., also playing the role of a receiving entity). Thus, an entity can send an event message to some receiving entities and receive event messages sent from some source entities at the same time. The event message sent from the entity is generally different from the received event messages.

In some examples, a first entity can send a first event message to a second entity through a first message queue. Meanwhile, the second entity can send a second event message to the first entity through a second message queue. Thus, a message loop comprising the first message queue and the second message queue can be created between the first entity and the second entity.

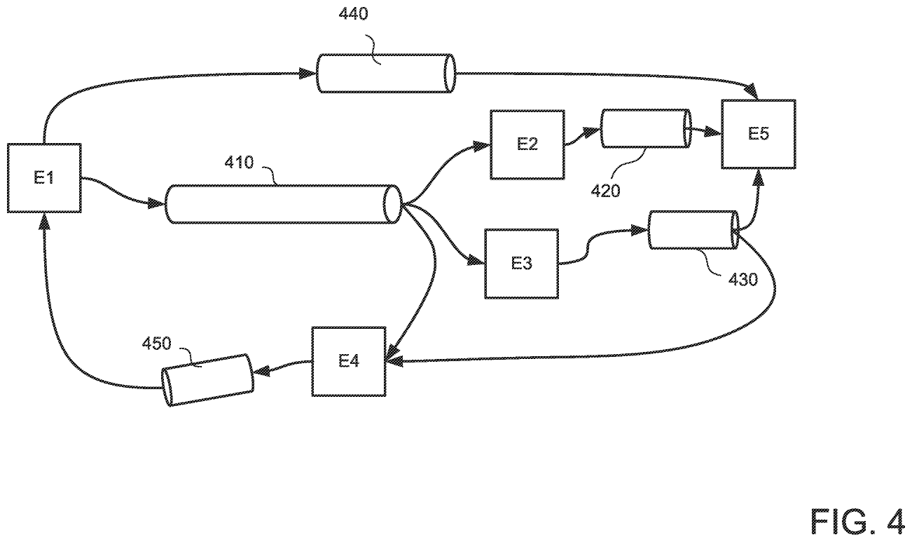

For illustrative purposes, FIG. 4 schematically illustrates a network of entities including E1, E2, E3, E4, and E5, that are interconnected to each other via a plurality of message queues 410, 420, 430, 440, and 450. In this example, the message queue 410 connects E1 (acting as a source entity) to E2, E3, and E4 (all acting as receiving entities); the message queue 420 makes a one-to-one connection between E2 (acting as a source entity) and E5 (acting as a receiving entity); the message queue 430 connects E3 (acting as a source entity) to E4 and E5 (both acting as receiving entities); the message queue makes a one-to-one connection between E1 (acting as a source entity) and E5 (acting as a receiving entity); and the message queue 450 makes a one-to-one connection between E4 (acting as a source entity) and E1 (acting as a receiving entity).

As shown, each entity can act as both a source entity and a receiving entity as the same time. An entity can be a source entity connected to several different receiving entities, e.g., E1 serves as a source entity for four receiving entities (E2, E3, E4, and E5) via two different message queues (410, 440). An entity can also be a receiving entity connected to several different source entities, e.g., E5 serves as a receiving entity for three different source entities (E1, E2, E3) via three different message queues (440, 420, 430). Additionally, multiple message loops (e.g., E1-410-E4-450-E1; E1-410-E3-430-E4-450-E1) are formed in the entity network.

### Example 11—Example Use Case

One example use case of supply chain financing is described herein to illustrate the benefits of cross-tenant collaboration based on the event proxy platform described above, although it should be understood that the same principles apply to many other use cases.

Supply chain financing process often involves a group of entities with different roles, such as suppliers, buyers, distributors, banks, etc. Corporation among these entities require an efficient way of exchanging data in real-time or substantially in rea-time. However, when different entities use different enterprise software systems, it can be technically challenging to integrate these heterogenous systems to support information exchange.

By introducing the event proxy platform, different entities can efficiently exchange data in a supply chain financing network through a streamlined registration (e.g., for entities and event objects) and subscription (e.g., for event subscriptions) mechanism. A registered entity can publish a registered event object on the event proxy platform. Thereafter, the event proxy platform will automatically handle the remaining tasks, such as parsing the event object, performing a DPP check, identifying receiving entities, creating message queues connected to secure message channels, sending notifications, etc. Based on the event proxy platform, a cross-tenant business process can be completed by handling one event object or a series of related event objects.

In one specific example, a bank needs to know the status of a purchase order of a company so that the bank can decide when to provide the financing. In such a scenario, the company can register an event object “purchase order released” on the event proxy platform. The bank can subscribe to this event object on the same event proxy platform. Thus, when a purchase order is released by the company, the “purchase order released” event object is published. So long as the company specifies the bank as one of its target entities in the event object, the bank will be immediately notified and receive relevant data (e.g., the posted event message of the event object). Based on the received data, the bank can decide if a financing request should be created. The bank and the company can complete such cross-tenant business transaction in nearly real-time (assuming the delay of event message on the message queue is negligible). In a supply chain finance network, one bank may have hundreds of companies as its customers and one company may work with a plurality of banks (see, e.g., FIG. 4). Although the banks and companies may use different IT solutions, using the event proxy platform, the banks and the companies do not need to know the details of software architecture/interface of all counterparts' IT systems to communicate with each other. Instead, they can focus on the standard event object handling (e.g., registration and subscription) in the common event proxy platform and their own IT systems.

### Example 12—Example Advantages

A number of advantages can be achieved via the technologies described herein. As described above, the conventional approach of using API calls to support cross-tenant collaboration is inefficient and lacks system extensibility. The technologies described herein allows all entities involved in a business process to be easily connected to each other by an event proxy platform. For the entities, the tasks are reduced to streamlined event registration and subscription steps, and the overhead of developing dedicated integration software applications based on specific APIs is eliminated. Once an event object is published by a source entity, entities who have subscribed to this event object can be informed immediately, and receive relevant information that is needed to perform follow-on activities in response to the event object. All these steps are performed through a secure message channel which is isolated from other message channels.

Although message-oriented middleware has been used some other applications, directly implementing the messaging brokers for cross-tenant collaboration in a multitenant computing environment is technologically challenging for a number of reasons. First, conventional message brokers do not support filtering recipients. For example, in a network of entities using a message broker for communications, a message posted by one entity on a message queue can be received by all other entities in the network. The event proxy platform described herein allows a source entity to specify target entities who are authorized to receive a posted event message, and further uses event subscriptions to filter who can actually receive the posted event message, thus providing point-to-point secure/isolated and reliable message channels to complete end-to-end business transactions. Second, conventional message brokers have no mechanism to handle data security and privacy issues. This problem is resolved by incorporating a security handler (e.g., 265) in the event proxy platform, which can mask sensitive data and/or remove the event message from the message queue based on DPP protocols specified by the security handler. Furthermore, different message brokers have different technical specifications and APIs. Directly interfacing with different message brokers may requires extensive learning and training, thus leading to a higher deployment cost. In contrast, the event proxy platform described herein is logically decoupled from the message brokers while encapsulating software interfaces to the external message brokers. Users do not need to know how to invoke specific messaging functions. Instead, the users only need to register with the event proxy platform which will take care of message handling processes automatically.

Thus, the technology described herein allows different entities in a business environment with heterogenous IT solutions to communicate with each other through a common user-interface of the event proxy platform, thus achieving cross-tenant collaboration efficiently, securely, and with a low cost. Cross-tenant system integration can be achieved by plug-and-play through a registration-subscription model, eliminating the system dependency.

### Example 13—Example Computing Systems

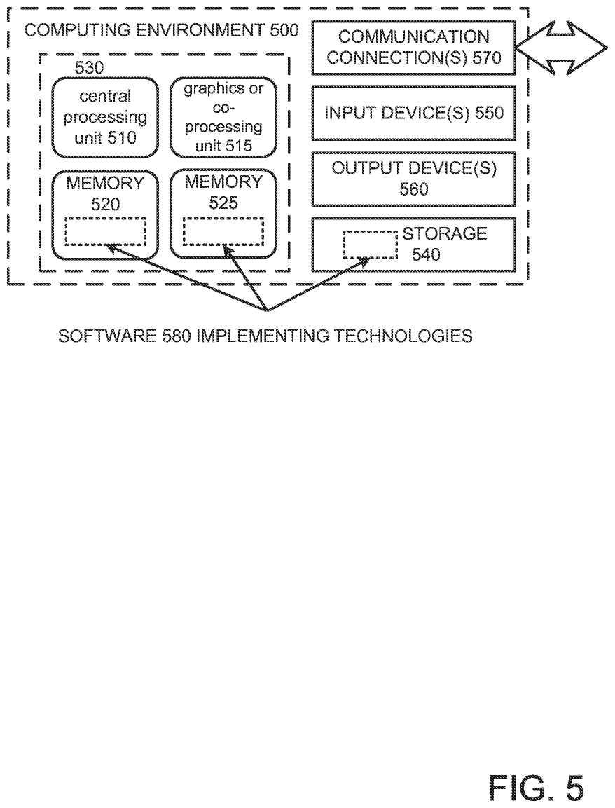

FIG. 5 depicts an example of a suitable computing system 500 in which the described innovations can be implemented. The computing system 500 is not intended to suggest any limitation as to scope of use or functionality of the present disclosure, as the innovations can be implemented in diverse computing systems.

With reference to FIG. 5, the computing system 500 includes one or more processing units 510, 515 and memory 520, 525. In FIG. 5, this basic configuration 530 is included within a dashed line. The processing units 510, 515 can execute computer-executable instructions, such as for implementing the features described in the examples herein (e.g., the method 300). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 5 shows a central processing unit 510 as well as a graphics processing unit or co-processing unit 515. The tangible memory 520, 525 can be volatile memory (e.g., registers, cache, RAM), non-volatile memory (e.g., ROM, EEPROM, flash memory, etc.), or some combination of the two, accessible by the processing unit(s) 510, 515. The memory 520, 525 can store software 580 implementing one or more innovations described herein, in the form of computer-executable instructions suitable for execution by the processing unit(s) 510, 515.

A computing system 500 can have additional features. For example, the computing system 500 can include storage 540, one or more input devices 550, one or more output devices 560, and one or more communication connections 570, including input devices, output devices, and communication connections for interacting with a user. An interconnection mechanism (not shown) such as a bus, controller, or network can interconnect the components of the computing system 500. Typically, operating system software (not shown) can provide an operating environment for other software executing in the computing system 500, and coordinate activities of the components of the computing system 500.

The tangible storage 540 can be removable or non-removable, and includes magnetic disks, magnetic tapes or cassettes, CD-ROMs, DVDs, or any other medium which can be used to store information in a non-transitory way and which can be accessed within the computing system 500. The storage 540 can store instructions for the software 280 implementing one or more innovations described herein.

The input device(s) 550 can be an input device such as a keyboard, mouse, pen, or trackball, a voice input device, a scanning device, touch device (e.g., touchpad, display, or the like) or another device that provides input to the computing system 500. The output device(s) 560 can be a display, printer, speaker, CD-writer, or another device that provides output from the computing system 500.

The communication connection(s) 570 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Example 14—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example 15—Example Cloud Computing Environment

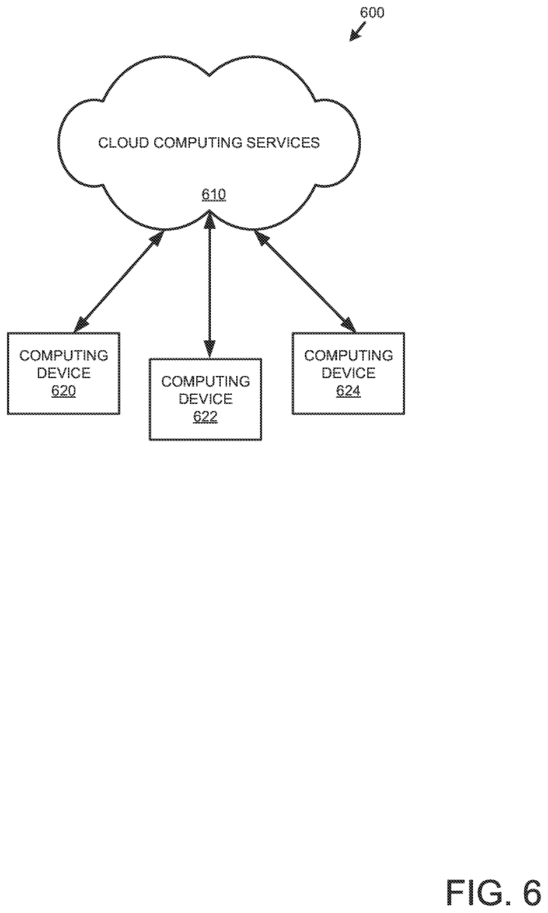

FIG. 6 depicts an example cloud computing environment 600 in which the described technologies can be implemented, including, e.g., the system 100 and other systems herein. The cloud computing environment 600 can include cloud computing services 610. The cloud computing services 610 can comprise various types of cloud computing resources, such as computer servers, data storage repositories, networking resources, etc. The cloud computing services 610 can be centrally located (e.g., provided by a data center of a business or organization) or distributed (e.g., provided by various computing resources located at different locations, such as different data centers and/or located in different cities or countries).

The cloud computing services 610 can be utilized by various types of computing devices (e.g., client computing devices), such as computing devices 620, 622, and 623. For example, the computing devices (e.g., 620, 622, and 624) can be computers (e.g., desktop or laptop computers), mobile devices (e.g., tablet computers or smart phones), or other types of computing devices. For example, the computing devices (e.g., 620, 622, and 624) can utilize the cloud computing services 610 to perform computing operations (e.g., data processing, data storage, and the like).

In practice, cloud-based, on-premises-based, or hybrid scenarios can be supported.

### Example 16—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### Example 17—Example Embodiments

Any of the following example embodiments can be implemented.
Example 1. A computer-implemented method comprising: receiving an event object published by a source entity; parsing the event object, wherein the parsing comprises retrieving an event message and one or more target entities from the event object, wherein the event message comprises data about an event awaiting processing, wherein the one or more target entities are authorized to process the event; identifying, from the one or more target entities, one or more receiving entities having subscribed to the event object; creating a message queue connected with one or more message routes that directly link the source entity to the respective one or more receiving entities; and posting the event message to the message queue.
Example 2. The method of example 1, further comprising: responsive to posting the event message, sending notifications to the one or more receiving entities.
Example 3. The method of any one of examples 1-2, wherein the parsing further comprises retrieving a topic from the event object, wherein the identifying one or more receiving entities comprises determining the one or more receiving entities have a subscription to the topic.
Example 4. The method of any one of examples 1-3, further comprising registering entities in a database through a user interface, wherein the entities comprise the source entity and the one or more receiving entities.
Example 5. The method of example 4, further comprising registering the event object in the database through the user interface before the event object is published by the source entity.
Example 6. The method of example 5, further comprising registering event subscriptions in the database through the user interface, wherein the event subscriptions indicate the one or more receiving entities have subscribed to the registered event object.
Example 7. The method of example 6, further comprising editing or deleting, through the user interface, one or more of the entities, the event object, or one or more of the event subscriptions registered in the database.
Example 8. The method of any one of examples 1-7, wherein the parsing further comprises retrieving one or more condition parameters from the event object, wherein the one or more condition parameters specify conditions for processing the event.
Example 9. The method of any one of examples 1-8, further comprising masking at least a portion of the event message according to a data privacy and protection protocol before posting the event message to the message queue.
Example 10. The method of any one of examples 1-9, further comprising deleting the event message from the message queue after at least one of the receiving entities has received the event message or after a predefined duration has passed since posting the event message to the message queue.
Example 11. A computing system, comprising: memory; one or more hardware processors coupled to the memory; and one or more computer readable storage media storing instructions that, when loaded into the memory, cause the one or more hardware processors to perform operations comprising: receiving an event object published by a source entity; parsing the event object, wherein the parsing comprises retrieving an event message and one or more target entities from the event object, wherein the event message comprises data about an event awaiting processing, wherein the one or more target entities are authorized to process the event; identifying, from the one or more target entities, one or more receiving entities having subscribed to the event object; creating a message queue connected with one or more message routes that directly link the source entity to the respective one or more receiving entities; posting the event message to the message queue; and responsive to posting the event message, sending notifications to the one or more receiving entities.
Example 12. The system of example 11, wherein the parsing further comprises retrieving a topic from the event object, wherein the identifying one or more receiving entities comprises determining the one or more receiving entities have a subscription to the topic.
Example 13. The system of any one of examples 11-12, wherein the operations further comprise registering entities in a database through a user interface, wherein the entities comprise the source entity and the one or more receiving entities.
Example 14. The system of example 13, wherein the operations further comprise registering the event object in the database through the user interface before the event object is published by the source entity.
Example 15. The system of example 14, wherein the operations further comprise registering event subscriptions in the database through the user interface, wherein the event subscriptions indicate the one or more receiving entities have subscribed to the registered event object.
Example 16. The system of example 15, wherein the operations further comprise editing or deleting, through the user interface, one or more of the entities, the event object, or one or more of the event subscriptions registered in the database.
Example 17. The system of any one of examples 11-16, wherein the parsing further comprises retrieving one or more condition parameters from the event object, wherein the one or more condition parameters specify conditions for processing the event.
Example 18. The system of any one of examples 11-17, wherein the operations further comprise masking at least a portion of the event message according to a data privacy and protection protocol before posting the event message to the message queue.
Example 19. The system of any one of examples 11-18, wherein the operations further comprise deleting the event message from the message queue after at least one of the receiving entities has received the event message or after a predefined duration has passed since posting the event message to the message queue.
Example 20. One or more non-transitory computer-readable media having encoded thereon computer-executable instructions causing one or more processors to perform a method comprising: receiving an event object published by a source entity; parsing the event object, wherein the parsing comprises retrieving an event message and one or more target entities from the event object, wherein the event message comprises data about an event awaiting processing, wherein the one or more target entities are authorized to process the event; identifying, from the one or more target entities, one or more receiving entities having subscribed to the event object; creating a message queue connected with one or more message routes that directly link the source entity to the respective one or more receiving entities; posting the event message to the message queue; responsive to posting the event message, sending notifications to the one or more receiving entities; and deleting the event message from the message queue after at least one of the receiving entities has received the event message or after a predefined duration has passed since posting the event message to the message queue.
Example 18—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving an event object published by a source entity;
parsing the event object, wherein the parsing comprises retrieving an event message and one or more target entities from the event object, wherein the event message comprises data about an event awaiting processing, wherein the one or more target entities are authorized to process the event;
identifying, from the one or more target entities, one or more receiving entities having subscribed to the event object;
creating a message queue connected with one or more message routes that directly link the source entity to the respective one or more receiving entities; and
posting the event message to the message queue.

2. The method of claim 1, further comprising:
responsive to posting the event message, sending notifications to the one or more receiving entities.

3. The method of claim 1, wherein the parsing further comprises retrieving a topic from the event object, wherein the identifying one or more receiving entities comprises determining the one or more receiving entities have a subscription to the topic.

4. The method of claim 1, further comprising registering entities in a database through a user interface, wherein the entities comprise the source entity and the one or more receiving entities.

5. The method of claim 4, further comprising registering the event object in the database through the user interface before the event object is published by the source entity.

6. The method of claim 5, further comprising registering event subscriptions in the database through the user interface, wherein the event subscriptions indicate the one or more receiving entities have subscribed to the registered event object.

7. The method of claim 6, further comprising editing or deleting, through the user interface, one or more of the entities, the event object, or one or more of the event subscriptions registered in the database.

8. The method of claim 1, wherein the parsing further comprises retrieving one or more condition parameters from the event object, wherein the one or more condition parameters specify conditions for processing the event.

9. The method of claim 1, further comprising masking at least a portion of the event message according to a DPP protocol before posting the event message to the message queue.

10. The method of claim 1, further comprising deleting the event message from the message queue after at least one of the receiving entities has received the event message or after a predefined duration has passed since posting the event message to the message queue.

11. A computing system, comprising:
memory;
one or more hardware processors coupled to the memory; and
one or more computer readable storage media storing instructions that, when loaded into the memory, cause the one or more hardware processors to perform operations comprising:
receiving an event object published by a source entity;
parsing the event object, wherein the parsing comprises retrieving an event message and one or more target entities from the event object, wherein the event message comprises data about an event awaiting processing, wherein the one or more target entities are authorized to process the event;
identifying, from the one or more target entities, one or more receiving entities having subscribed to the event object;
creating a message queue connected with one or more message routes that directly link the source entity to the respective one or more receiving entities;
posting the event message to the message queue; and
responsive to posting the event message, sending notifications to the one or more receiving entities.

12. The system of claim 11, wherein the parsing further comprises retrieving a topic from the event object, wherein the identifying one or more receiving entities comprises determining the one or more receiving entities have a subscription to the topic.

13. The system of claim 11, wherein the operations further comprise registering entities in a database through a user interface, wherein the entities comprise the source entity and the one or more receiving entities.

14. The system of claim 13, wherein the operations further comprise registering the event object in the database through the user interface before the event object is published by the source entity.

15. The system of claim 14, wherein the operations further comprise registering event subscriptions in the database through the user interface, wherein the event subscriptions indicate the one or more receiving entities have subscribed to the registered event object.

16. The system of claim 15, wherein the operations further comprise editing or deleting, through the user interface, one or more of the entities, the event object, or one or more of the event subscriptions registered in the database.

17. The system of claim 11, wherein the parsing further comprises retrieving one or more condition parameters from the event object, wherein the one or more condition parameters specify conditions for processing the event.

18. The system of claim 11, wherein the operations further comprise masking at least a portion of the event message according to a DPP protocol before posting the event message to the message queue.

19. The system of claim 11, wherein the operations further comprise deleting the event message from the message queue after at least one of the receiving entities has received the event message or after a predefined duration has passed since posting the event message to the message queue.

20. One or more non-transitory computer-readable media having encoded thereon computer-executable instructions causing one or more processors to perform a method comprising:
receiving an event object published by a source entity;
parsing the event object, wherein the parsing comprises retrieving an event message and one or more target entities from the event object, wherein the event message comprises data about an event awaiting processing, wherein the one or more target entities are authorized to process the event;
identifying, from the one or more target entities, one or more receiving entities having subscribed to the event object;
creating a message queue connected with one or more message routes that directly link the source entity to the respective one or more receiving entities;
posting the event message to the message queue;
responsive to posting the event message, sending notifications to the one or more receiving entities; and
deleting the event message from the message queue after at least one of the receiving entities has received the event message or after a predefined duration has passed since posting the event message to the message queue.
